(19) United States
(12) Patent Application Publication
(10) Pub. No.: US 2015/0058414 A1
(43) Pub. Date: Feb. 26, 2015

(54) DIAMETER INTEROPERABILITY FACILITATION

(71) Applicant: ALCATEL-LUCENT CANADA INC., OTTAWA (CA)

(72) Inventors: Robert A. MANN, Carp (CA); Darryl W. JAAKKOLA, Carp (CA)

(73) Assignee: ALCATEL-LUCENT CANADA INC., OTTAWA (CA)

(21) Appl. No.: 13/970,908

(22) Filed: Aug. 20, 2013

(51) Int. Cl. H04L 29/06

(52) U.S. Cl. CPC H04L 65/403
USPC 709/204

(57) ABSTRACT

Various exemplary embodiments relate to a method and related network node including one or more of the following: obtaining a Diameter message to be transmitted to a client device, wherein the Diameter message includes a first Diameter identity; determining, based on a configuration of the Diameter device, that an alternate identity is to be presented to the client device; replacing the first Diameter identity with a second Diameter identity that is different from the first Diameter identity, based on the determination that an alternate identity is to be presented to the client device; and transmitting the Diameter message to the client device.

### CROSS-REFERENCE TO RELATED APPLICATIONS

This application is related to the following co-pending applications, which are hereby incorporated by reference for all purposes as if fully set forth herein: application Ser. No. 13/482,690, filed on May 29, 2012, “ORGANIZATION OF DIAMETER ROUTING AGENT RULE SETS;” application Ser. No. 13/482,587, filed on May 29, 2012, “ROUTING DECISION CONTEXT OBJECTS;” application Ser. No. 13/602,579, filed on Sep. 4, 2012, “RULE ENGINE EVALUATION OF CONTEXT OBJECTS.”

This application is related to the following co-pending applications, which are hereby incorporated by reference for all purposes as if fully set forth herein: application Ser. No. 13/962,071 “GENERIC PERSISTENCE IN A DIAMETER ROUTING AGENT” filed on Aug. 8, 2013; application Ser. No. 13/343,378, “SUBSCRIBER ASSIGNMENT” filed on Jan. 4, 2012.

### TECHNICAL FIELD

Various exemplary embodiments disclosed herein relate generally to communications networking.

### BACKGROUND

Since its proposal in Internet Engineering Task Force (IETF) Request for Comments (RFC) 3588, the Diameter protocol has been increasingly adopted by numerous networked applications. For example, the Third Generation Partnership Project (3GPP) has adopted Diameter for various policy and charging control (PCC), mobility management, and IP multimedia subsystem (IMS) applications. As IP-based networks replace circuit-switched networks, Diameter is even replacing SS7 as the key communications signaling protocol. As networks evolve, Diameter is becoming a widely used protocol among wireless and wireline communications networks.

One significant aspect of the Diameter protocol is Diameter packet routing. Entities referred to as Diameter routing agents (DRAB) facilitate movement of packets in a network. In various deployments, DRAs may perform elementary functions such as simple routing, proxying, and redirect.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various embodiments described herein relate to a method performed by a Diameter device for processing a Diameter message, the method including: obtaining a Diameter message to be transmitted to a client device, wherein the Diameter message includes a first Diameter identity; determining, based on a configuration of the Diameter device, that an alternate identity is to be presented to the client device; replacing the first Diameter identity with a second Diameter identity that is different from the first Diameter identity, based on the determination that an alternate identity is to be presented to the client device; and transmitting the Diameter message to the client device.

Various embodiments described herein relate to a Diameter device for processing a Diameter message, the Diameter device including: a network interface; and a processor in communication with the network interface, wherein the processor is configured to: provide a Diameter stack for communicating via the network interface, wherein the Diameter stack is configured to: obtain a Diameter message to be transmitted to a client device, wherein the Diameter message includes a first Diameter identity, pass the Diameter message to an application of the processor, and transmit the Diameter message to the client device after receiving the Diameter message back from the application; and provide an application for processing Diameter messages, wherein the application is configured to: receive the Diameter message from the Diameter stack, determine, based on a configuration of the Diameter device, that an alternate identity is to be presented to the client device, replace the first Diameter identity with a second Diameter identity that is different from the first Diameter identity, based on the determination that an alternate identity is to be presented to the client device, and return the Diameter message to the Diameter stack for transmission.

Various embodiments described herein relate to a non-transitory machine-readable storage medium encoded with instructions for execution by a Diameter device for processing a Diameter message, the medium including: instructions for obtaining a Diameter message to be transmitted to a client device, wherein the Diameter message includes a first Diameter identity; instructions for determining, based on a configuration of the Diameter device, that an alternate identity is to be presented to the client device; instructions for replacing the first Diameter identity with a second Diameter identity that is different from the first Diameter identity, based on the determination that an alternate identity is to be presented to the client device; and instructions for transmitting the Diameter message to the client device.

Various embodiments are described wherein: obtaining the Diameter message includes generating the Diameter message, and the first Diameter identity is a true Diameter identity of the Diameter device.

Various embodiments are described wherein: obtaining the Diameter message includes receiving a Diameter message from a different Diameter device, the first Diameter identity is a true Diameter identity of the different Diameter device, and the second Diameter identity is at least one of a true Diameter identity of the Diameter device and a substitute Diameter identity defined by the configuration of the Diameter device.

Various embodiments are described wherein the configuration of the Diameter device is an externalized rule evaluated by a rule engine of the Diameter device.

Various embodiments are described wherein the Diameter message is one of a Capabilities Exchange Request and a Capabilities Exchange Answer, the method further including: identifying a record from a Diameter peer table; generating at least one attribute-value pair (AVP) based on the record; and inserting the at least one AVP into the Diameter message.

Various embodiments are described wherein: the first Diameter identity includes a first host name and a first realm name; the second Diameter identity includes a second host name and a second realm name; and the first host name is the same as the second host name.

Various embodiments additionally include before transmitting the Diameter message: determining, by a Diameter stack of the Diameter device, that the second Diameter identity is different from a true Diameter identity of the Diameter device, and storing a record of the second Diameter identity in association with an identity of the client device; and inserting, by the Diameter stack, the second Diameter identity into at least one additional Diameter message destined for the client device based on the stored record.

### BRIEF DESCRIPTION OF THE DRAWINGS

In order to better understand various exemplary embodiments, reference is made to the accompanying drawings, wherein:

FIG. 1 illustrates an exemplary network environment for a Diameter Routing Agent;

FIG. 2 illustrates a component diagram of an exemplary Diameter Routing Agent;

FIG. 3 illustrates a hardware diagram of an exemplary Diameter Routing Agent;

FIG. 4 illustrates an exemplary method for processing Diameter messages;

FIG. 5 illustrates an exemplary method for establishing a message context object;

FIG. 6 illustrates an exemplary method for copying peer abilities into a capabilities exchange message;

FIG. 7 illustrates an exemplary component diagram for a Diameter stack;

FIG. 8 illustrates an exemplary method for presenting an alternate identity at a Diameter stack;

FIG. 9 illustrates an alternative embodiment of a Diameter Routing Agent;

FIG. 10 illustrates an exemplary table for storing alternative Diameter identity configuration information; and

FIG. 11 illustrates an exemplary method for presenting an alternative Diameter identity to another device.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments can be combined with one or more other embodiments to form new embodiments. As used herein, the terms “context” and “context object” will be understood to be synonymous, unless otherwise indicated.

Diameter Routing Agents (DRAs) and other Diameter devices are generally expected to interface with many different types of devices from different vendors, often devices with different and non-standard implementations. For example, some devices will ignore or otherwise not properly process messages forwarded by a DRA or other device when the origin host or realm carried by the message are not the Diameter identity of the DRA itself. In other words, some devices expect to be served only by the devices to which they are directly attached and therefore do not operate properly in the presence of intermediate Diameter nodes, such as DRAs. In view of the foregoing, it would be desirable to provide a method and system that enables a Diameter-based device to modify appropriate Diameter messages such that the DRA appears to directly serve such special-case devices.

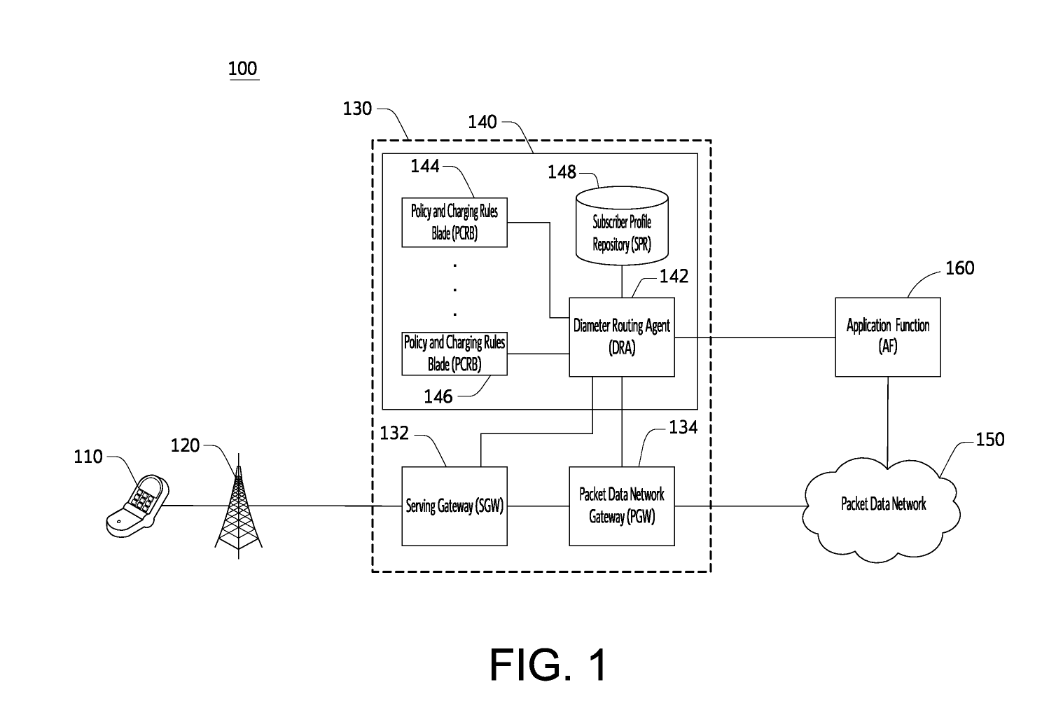

FIG. 1 illustrates an exemplary network environment 100 for a Diameter Routing Agent (DRA) 142. Exemplary network environment 100 may be a subscriber network for providing various services. In various embodiments, subscriber network 100 may be a public land mobile network (PLMN). Exemplary subscriber network 100 may be telecommunications network or other network for providing access to various services. Exemplary subscriber network 100 may include user equipment 110, base station 120, evolved packet core (EPC) 130, packet data network 150, and application function (AF) 160.

User equipment 110 may be a device that communicates with packet data network 150 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, tablet, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by the relevant 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with EPC 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the relevant 3GPP standards. EPC 130 may include a serving gateway (SGW) 132, a packet data network gateway (PGW) 134, and a session control device 140.

Serving gateway (SGW) 132 may be a device that provides gateway access to the EPC 130. SGW 132 may be one of the first devices within the EPC 130 that receives packets sent by user equipment 110. Various embodiments may also include a mobility management entity (MME) (not shown) that receives packets prior to SGW 132. SGW 132 may forward such packets toward PGW 134. SGW 132 may perform a number of functions such as, for example, managing mobility of user equipment 110 between multiple base stations (not shown) and enforcing particular quality of service (QoS) characteristics for each flow being served. In various implementations, such as those implementing the Proxy Mobile IP standard, SGW 132 may include a Bearer Binding and Event Reporting Function (BBERF). In various exemplary embodiments, EPC 130 may include multiple SGWs (not shown) and each SGW may communicate with multiple base stations (not shown).

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Therefore, PGW 134 may be a policy and charging enforcement node (PCEN). PGW 134 may include a number of additional features such as, for example, packet filtering, deep packet inspection, and subscriber charging support. PGW 134 may also be responsible for requesting resource allocation for unknown application services.

Session control device 140 may be a device that provides various management or other functions within the EPC 130. For example, session control device 140 may provide a Policy and Charging Rules Function (PCRF). In various embodiments, session control device 140 may include an Alcatel Lucent 5780 Dynamic Services Controller (DSC). Session control device 140 may include a DRA 142, a plurality of policy and charging rules blades (PCRBs) 144, 146, and a subscriber profile repository 148.

As will be described in greater detail below, DRA 142 may be an intelligent Diameter Routing Agent. As such, DRA 142 may receive, process, and transmit various Diameter messages. DRA 142 may include a number of user-defined rules that govern the behavior of DRA 142 with regard to the various Diameter messages DRA 142 may encounter. Based on such rules, the DRA 142 may operate as a relay agent, proxy agent, or redirect agent. For example, DRA 142 may relay received messages to an appropriate recipient device. Such routing may be performed with respect to incoming and outgoing messages, as well as messages that are internal to the session control device.

Policy and charging rules blades (PCRB) 144, 146 may each be a device or group of devices that receives requests for application services, generates PCC rules, and provides PCC rules to the PGW 134 or other PCENs (not shown). PCRBs 144, 146 may be in communication with AF 160 via an Rx interface. As described in further detail below with respect to AF 160, PCRB 144, 146 may receive an application request in the form of an Authentication and Authorization Request (AAR) from AF 160. Upon receipt of an AAR, PCRB 144, 146 may generate at least one new PCC rule for fulfilling the application request.

PCRB 144, 146 may also be in communication with SGW 132 and PGW 134 via a Gxx and a Gx interface, respectively. PCRB 144, 146 may receive an application request in the form of a credit control request (CCR) from SGW 132 or PGW 134. As with an AAR, upon receipt of a CCR, PCRB 144, 146 may generate at least one new PCC rule for fulfilling the application request. In various embodiments, the AAR and the CCR may represent two independent application requests to be processed separately, while in other embodiments, the AAR and the CCR may carry information regarding a single application request and PCRB 144, 146 may create at least one PCC rule based on the combination of the AAR and the CCR. In various embodiments, PCRB 144, 146 may be capable of handling both single-message and paired-message application requests.

Upon creating a new PCC rule or upon request by the PGW 134, PCRB 144, 146 may provide a PCC rule to PGW 134 via the Gx interface. In various embodiments, such as those implementing the proxy mobile IP (PMIP) standard for example, PCRB 144, 146 may also generate QoS rules. Upon creating a new QoS rule or upon request by the SGW 132, PCRB 144, 146 may provide a QoS rule to SGW 132 via the Gxx interface.

Subscriber profile repository (SPR) 148 may be a device that stores information related to subscribers to the subscriber network 100. Thus, SPR 148 may include a machine-readable storage medium such as read-only memory (ROM), random-access memory (RAM), magnetic disk storage media, optical storage media, flash-memory devices, and/or similar storage media. SPR 148 may be a component of one of PCRB 144, 146 or may constitute an independent node within EPC 130 or session control device 140. Data stored by SPR 148 may include subscriber information such as identifiers for each subscriber, bandwidth limits, charging parameters, and subscriber priority.

Packet data network 150 may be any network for providing data communications between user equipment 110 and other devices connected to packet data network 150, such as AF 160. Packet data network 150 may further provide, for example, phone or Internet service to various user devices in communication with packet data network 150.

Application function (AF) 160 may be a device that provides a known application service to user equipment 110. Thus, AF 160 may be a server or other device that provides, for example, a video streaming or voice communication service to user equipment 110. AF 160 may further be in communication with the PCRB 144, 146 of the EPC 130 via an Rx interface. When AF 160 is to begin providing known application service to user equipment 110, AF 160 may generate an application request message, such as an authentication and authorization request (AAR) according to the Diameter protocol, to notify the PCRB 144, 146 that resources should be allocated for the application service. This application request message may include information such as an identification of the subscriber using the application service, an IP address of the subscriber, an APN for an associated IP-CAN session, or an identification of the particular service data flows that must be established in order to provide the requested service.

As will be understood, various Diameter applications may be established within subscriber network 100 and supported by DRA 142. For example, an Rx application may be established between AF 160 and each of PCRBs 144, 146. As another example, an Sp application may be established between SPR 148 and each of PCRBs 144, 146. As yet another example, an S9 application may be established between one or more of PCRBs 144, 146 and a remote device implementing another PCRF (not shown). As will be understood, numerous other Diameter applications may be established within subscriber network 100. In various embodiments, the DRA 142 may provide similar support to applications defined according to other protocols. For example, the DRA 142 may additionally provide support for RADIUS or SS7 applications. Various modifications to the techniques and components described herein for supporting such other protocols will be apparent.

In supporting the various potential Diameter applications, DRA 142 may receive Diameter messages, process the messages, and perform actions based on the processing. For example, DRA 142 may receive a Gx CCR from PGW 134, identify an appropriate PCRB 144, 146 to process the Gx CCR, and forward the Gx CCR to the identified PCRB 144, 146. DRA 142 may also act as a proxy by modifying the subsequent Gx CCA sent by the PCRB 144, 146 to carry an origin-host identification pointing to the DRA 142 instead of the PCRB 144, 146. Additionally or alternatively, DRA 142 may act as a redirect agent or otherwise respond directly to a request message by forming an appropriate answer message and transmitting the answer message to an appropriate requesting device.

As noted above, some implementations of various Diameter devices may not operate properly when communicating via an intermediate Diameter device, such as the DRA 142. For example, the PGW 134 may ignore messages received from the PCRBs 144, 146 because the messages may include the Diameter identifier of the appropriate PCRB 144, 146 while the PGW 134 expects all messages received from the DRA 142 to carry the Diameter identifier of the DRA 142 itself as may have been originally presented upon peer connection. As used herein, the term Diameter identifier will be understood to refer to an identifier used to refer to a specific Diameter device within a network, such as the combination of the device's realm and host names. Alternatively, the PGW 134 may operate correctly even when the message carries a different Diameter identifier from the DRA 142, but only when Diameter identifier carries the same realm as the DRA 142. To address these and other special cases, the DRA 142 may be configured to perform various message modifications when communicating with special case client devices to facilitate Diameter device interoperability. As used herein, the term “client device” will be understood to refer to any device interacting with the Diameter device (e.g., the DRA) and may include a peer device that is directly connected to the Diameter device (e.g., not connected through intermediate Diameter nodes) or a non-peer device that is at least one hop away from the Diameter device.

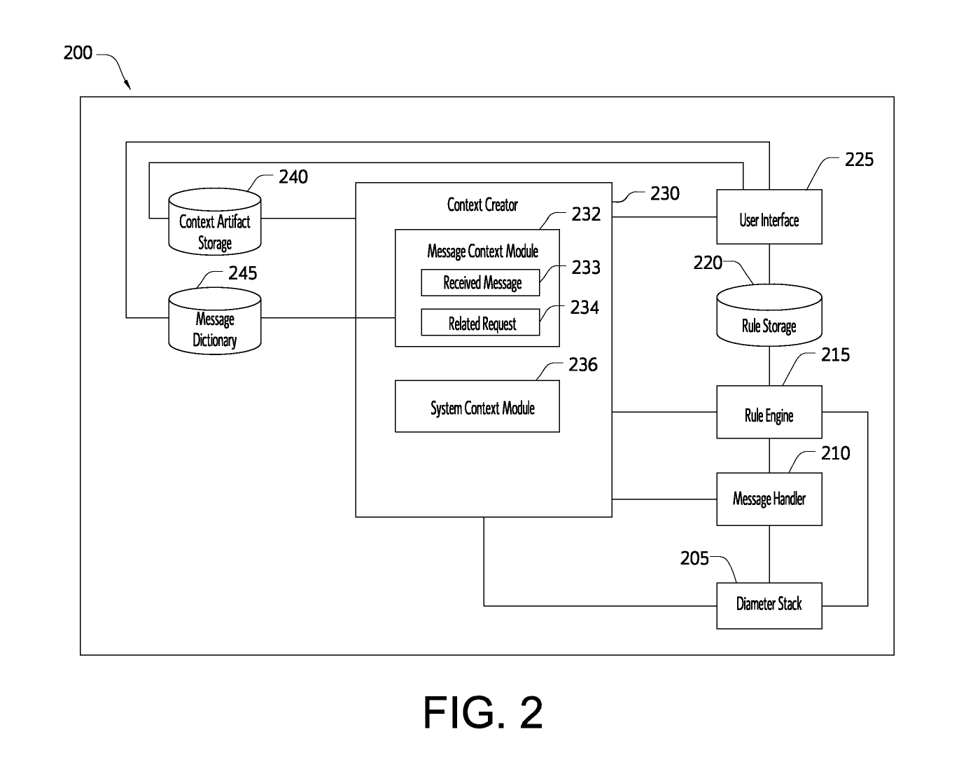

FIG. 2 illustrates an exemplary Diameter Routing Agent (DRA) 200. DRA 200 may be a standalone device or a component of another system. For example, DRA 200 may correspond to DRA 142 of exemplary environment 100. In such an embodiment, DRA 142 may support various Diameter applications defined by the 3GPP such as Gx, Gxx, Rx, or Sp. It will be understood that DRA 200 may be deployed in various alternative embodiments wherein additional or alternative applications are supported. As such, it will be apparent that the methods and systems described herein may be generally applicable to supporting any Diameter applications.

The DRA 200 may include a number of components such as Diameter stack 205, message handler 210, rule engine 215, rule storage 220, user interface 225, context creator 230, context artifact storage 240, and message dictionary 245.

Diameter stack 205 may include hardware or executable instructions on a machine-readable storage medium configured to exchange messages with other devices according to the Diameter protocol. Diameter stack 205 may include an interface including hardware or executable instructions encoded on a machine-readable storage medium configured to communicate with other devices. For example, Diameter stack 205 may include an Ethernet or TCP/IP interface. In various embodiments, Diameter stack 205 may include multiple physical ports.

Diameter stack 205 may also be configured to read and construct messages according to the Diameter protocol. For example, Diameter stack may be configured to read and construct CCR, CCA, AAR, AAA, RAR, and RAA messages. Diameter stack 205 may provide an application programmer's interface (API) such that other components of DRA 200 may invoke functionality of Diameter stack. For example, rule engine 215 may be able to utilize the API to read an attribute-value pair (AVP) from a received CCR or to modify an AVP of a new CCA. Various additional functionalities will be apparent from the following description.

Message handler 210 may include hardware or executable instructions on a machine-readable storage medium configured to interpret received messages and invoke rule engine 215 as appropriate. In various embodiments, message handler 210 may extract a message type from a message received by Diameter stack 205 and invoke the rule engine using a rule set that is appropriate for the extracted message type. For example, the message type may be defined by the application and command of the received message. After the rule engine 215 finishes evaluating one or more rules, message handler 210 may transmit one or more messages via Diameter stack based upon one or more context object actions invoked by the rule engine 215.

Rule engine 215 may include hardware or executable instructions on a machine-readable storage medium configured to process a received message by evaluating one or more rules stored in rule storage 220. As such, rule engine 215 may be a type of processing engine. Rule engine 215 may retrieve one or more rules, evaluate criteria of the rules to determine whether the rules are applicable, and specify one or more results of any applicable rules. For example, rule engine 215 may determine that a rule is applicable when a received Gx CCR includes a destination-host AVP identifying DRA 200. The rule may specify that the destination-host AVP should be changed to identify a PCRB before the message is forwarded.

Rule storage 220 may be any machine-readable medium capable of storing one or more rules for evaluation by rule engine 215. Accordingly, rule storage 220 may include a machine-readable storage medium such as read-only memory (ROM), random-access memory (RAM), magnetic disk storage media, optical storage media, flash-memory devices, and/or similar storage media. In various embodiments, rule storage 220 may store one or more rule sets as a binary decision tree data structure. Various other data structures for storing a rule set will be apparent.

It will be understood that, while various components are described as being configured to perform functions such as evaluating rules or accessing context objects based on rules, such configurations may not require any rules to be present in rule storage. For example, rule engine 215 may be configured to evaluate a rule including a context object reference even if no such rule is stored in rule storage 220. Thereafter, if a user adds such a rule to rule storage, rule engine 215 may process the rule as described herein. In other words, as used herein, the phrase “configured to” when used with respect to functionality related to rules will be understood to mean that the component is capable of performing the functionality as appropriate, regardless of whether a rule that requests such functionality is actually present.

User interface 225 may include hardware or executable instructions on a machine-readable storage medium configured to enable communication with a user. As such, user interface 225 may include a network interface (such as a network interface included in Diameter stack 205), a monitor, a keyboard, a mouse, or a touch-sensitive display. User interface 225 may also provide a graphical user interface (GUI) for facilitating user interaction. User interface 225 may enable a user to customize the behavior of DRA 200. For example, user interface 225 may enable a user to define rules for storage in rule storage 220 and evaluation by rule engine 215. Various additional methods for a user to customize the behavior of DRA 200 via user interface 225 will be apparent to those of skill in the art.

According to various embodiments, rule storage 220 may include rules that reference one or more “contexts” or “context objects.” In such embodiments, context creator 230 may include hardware or executable instructions on a machine-readable storage medium configured to instantiate context objects and provide context object metadata to requesting components. Context objects may be instantiated at run time by context creator 230 and may include attributes or actions useful for supporting the rule engine 215 and enabling the user to define complex rules via user interface 225. For example, context creator 230 may provide context objects representing various Diameter messages, previous routing decisions, or subscriber profiles.

Upon DRA 200 receiving a Diameter message to be processed, message handler 210 may send an indication to context creator 230 that the appropriate context objects are to be instantiated. Context creator 230 may then instantiate such context objects. In some embodiments, context creator 230 may instantiate all known context objects or may only instantiate those context objects actually used by the rule set to be applied by rule storage 220. In other embodiments, context creator 230 may not instantiate a context object until it is actually requested by the rule engine 215. In some embodiments, one or more context objects may be instantiated before a Diameter message is received, such that the same instance of the context object is utilized by the rule engine in processing multiple subsequent Diameter messages.

Context creator 230 may additionally facilitate rule creation by providing context metadata to user interface 225. In various embodiments, context creator 230 may indicate to user interface 225 which context objects may be available for a rule set being modified and what attributes or actions each context object may possess. Using this information, user interface 225 may present a point-and-click interface for creating complex rules. For example, user interface 225 may enable the user to select a desired attribute or action of a context object from a list for inclusion in a rule under construction or modification.

Context creator 230 may rely on one or more context artifacts stored in context artifact storage 240 in establishing context objects. As such, context artifact storage 240 may be any machine-readable medium capable of storing one or more context artifacts. Accordingly, context artifact storage 240 may include a machine-readable storage medium such as read-only memory (ROM), random-access memory (RAM), magnetic disk storage media, optical storage media, flash-memory devices, and/or similar storage media. Context artifact storage 240 may store artifacts in various forms such as, for example, run-time libraries. In various embodiments, such run-time libraries may be stored as Java archive (.jar) files.

Each context artifact may define the attributes or actions available for a context object. In various embodiments, the context artifact may define one or more functions to be executed when an attribute or action is accessed. Such functions may utilize other functionality of the DRA 200, such as accessing the API of the Diameter stack, or may return values to the component that called the attribute or action. The context artifact may also include tags or other metadata for context creator 230 to provide to user interface 225 for describing the actions and attributes of the context object. In exemplary DRA 200, context artifact storage 240 may store context artifacts defining a message context, a system context, or a generic binding context. These context artifacts may be used by context creator 230 at run-time to instantiate different types of context objects. As such, context creator 230 may be viewed as including a message context module 232, a system context module 234, and a generic binding context module 236. In various embodiments, a user may be able to define new context artifacts via user interface 225 for storage in context artifact storage, such as by specifying an existing file (e.g. a .jar file).

Message context module 232 may represent the ability of context creator 230 to generate context objects representing and providing access to Diameter messages. For example, message context module 232 may generate a context object representing the received message. In various embodiments, message context module 232 may also be configured to generate a context object representing a request message or an answer message associated with the received Diameter message, as appropriate. As such, message context module 232 may be viewed as including a received message submodule 233 and a related request submodule 234.

The contents of Diameter messages may vary depending on the application and command type. For example, an Rx RAA message may include different data from a GX CCR message. Such differences may be defined by various standards governing the relevant Diameter applications. Further, some vendors may include proprietary or otherwise non-standard definitions of various messages. Message context module 232 may rely on message definitions stored in message dictionary 245 to generate message contexts for different types of Diameter messages. For example, upon receiving a Diameter message, message handler 210 may pass the application and command type to the context creator 230. Message context module 232 may then locate a matching definition in message dictionary 245. This definition may indicate the AVPs that may be present in a message of the specified type. Message context module 232 may then instantiate a message context object having attributes and actions that match the AVPs identified in the message definition.

Message dictionary 245 may be any machine-readable medium capable of storing one or more context artifacts. Accordingly, message dictionary 245 may include a machine-readable storage medium such as read-only memory (ROM), random-access memory (RAM), magnetic disk storage media, optical storage media, flash-memory devices, and/or similar storage media. Message dictionary 245 may include various message definitions in appropriate forms such as, for example, XML files. Message dictionary 245 may include a number of predefined definitions included with the DRA 200 by a supplier. In various embodiments, a user may be able to provide new, user-defined message definitions via user interface 225. For example, if the user wishes to support an application not already defined by the predefined definitions, the user may generate or otherwise obtain a definition file for storage in message dictionary 245. In various embodiments, the user-defined definitions may be stored in a different portion of message dictionary, such as a different directory, from the predefined definitions.

In various embodiments, the user may also be able to extend predefined definitions via user interface 225. The user may be able to provide extension definitions that define new AVPs or specify additional AVPs to occur in a particular message type. For example, a user may wish to support a proprietary AVP within an Rx AAR. To provide such support, the user may provide a definition file, such as an XML file, defining the proprietary AVP and indicating that the proprietary AVP may be present in an Rx AAR. Such extension definitions may also be stored in a different area of message dictionary 245 from the predefined definitions. Message context module 232 may be configured to apply any applicable extension definitions when instantiating a new message context object or providing context metadata to user interface 225.

As noted above, upon receiving a Diameter message, message handler 210 may extract the application and command type and pass this information to context creator 230, which then may locate any applicable definitions to instantiate a new received message context object. Received message submodule 233 may be further configured to associate the new context object with the received Diameter message itself. For example, received message submodule 233 may copy the received Diameter message from Diameter stack 205 into a private or protected variable. Alternatively, received message submodule 233 may store an identification of the Diameter message useful in enabling access to the Diameter message via the API of the Diameter stack 205.

In various embodiments, DRA 200 may support the use of inverse message contexts. In such embodiments, upon extracting the command type from the received Diameter message, message handler 210 may identify the inverse message type as well. In some such embodiments, message handler 210 may implement a look-up table identifying the inverse for each message command. For example, upon determining that a received Diameter message is a Gx CCA, the message handler may determine that the inverse message would be a Gx CCR. Message handler 210 may pass this information to context creator 230 as well.

Upon receiving an inverse message type, message context module 232 may instantiate an inverse message context object in a manner similar to that described above with regard to the received message context object. Related request submodule 234 or related answer submodule 235, as appropriate, may also associate the new context object with message data. If the inverse message is a request message, related request submodule 234 may identify a previously-processed request message stored in Diameter stack 205 and associate the message with the new context object in a manner similar to that described above. In various embodiments, upon receiving an answer message, Diameter stack 205 may locate the previously-processed and forwarded request message to which the answer message corresponds. Diameter stack 205 may present this related request message through the API for use by context creator 230 or other components of DRA 200. By associating the previous request message with the related request context object, rule engine 215 may be provided with attributes capable of accessing the AVPs carried by the request message that prompted transmission of the answer message being processed.

As noted above, context creator 230 may be capable of defining other context objects that do not represent a Diameter message. Such context objects may be referred to as “computational contexts” and may also be defined by contexts artifacts in context artifact storage 240. Exemplary computational contexts may include objects that provide access to generic bindings, a subscription profile, a previous routing decision, a load balancer, and system level functions. Various additional computational contexts will be apparent.

As an example of a computational context, the system context module 234 may generate a system context object. The system context object may provide access to various system level functionality. For example, the system context object may provide access to a Diameter peer table, routing information stored in the Diameter stack 205, enable event logging, or enable administrator messaging via dialogs or email. Various alternative or additional system functionality to expose via the system context object will be apparent.

To facilitate interoperability with other Diameter devices, it may be desirable for an operator to configure the DRA to modify various Diameter messages to include non-standard information before forwarding the messages to various devices known to be associated with interoperability issues. For example, the user may write rules to change the values of origin host and realm AVPs when a received Gx message is to be sent to a specific device. Such a rule may be created and evaluated using various message contexts. It may also be desirable to effect similar changes to base Diameter protocol messages unassociated with a specific application. In other DRAs, base Diameter protocol messages may normally be handled entirely by the Diameter stack 205 without intervention by application-level components. In various embodiments described herein, the Diameter stack may be configured to present such base Diameter protocol messages to application-level components, such as the message handler 210, for modification prior to transmission. For example, upon generating a capabilities exchange request (CER), rather than immediately sending the CER to a peer device, the Diameter stack 205 may pass the new CER to the message handler 210. The message handler 210 may then process the CER as described above, including invoking the rules engine in conjunction with any rules sets defined for CER messages. In this manner, the operator may define specific modifications to the CER message.

Similarly, when the Diameter stack 205 receives a CER message from another device, the Diameter stack 205 may proceed to create a capabilities exchange answer (CEA) based on the configuration of the system. Then, before sending the CEA in response, the Diameter stack 205 may pass the CEA to the message handler 210 for processing as described above, including invocation of the rules engine with any CEA rules sets. In accordance with the related request submodule 234 described above, the various rules in the rule sets may also refer to the contents of the received CER message.

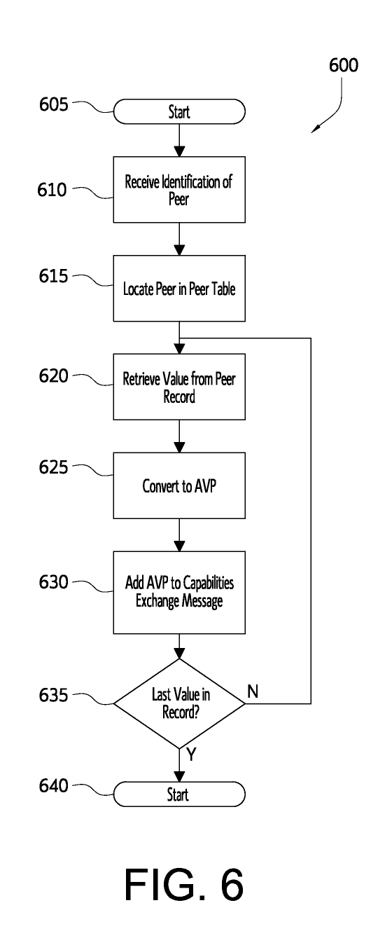

The system context may be further extended to provide various helper functions for modifying CER and CEA messages. For example, the system context object may be provided with a “Copy-Peer-To-Capabilities-Exchange” action. An operator may be able to create a rule that calls this action and specifies a peer known to the DRA 200. The context may then locate a record for that peer in the Diameter stack's 205 peer table and copy the previously reported information for that peer into the current CER or CEA. An exemplary method for accomplishing such an action will be described in greater detail below with respect to FIG. 6. In this manner, the DRA 200 may be able to advertise the capabilities of a previously-attached peer such as, for example, a PCRB, to another client device that assumes that it is directly attached to the serving device.

The system context may be extended in various additional ways. For example, the system context may provide an “Peer-Table.Is-Connected” attribute for determining whether a particular peer is connected. An operator may use such an action in a rule to determine whether the peer is connected before trying to copy that peer's information to the CER or CEA. It will also be understood that in addition to, or instead of, modifying the system context, the CER and CEA contexts may be provided with methods for accessing the peer table. For example, each AVP within the CER and CEA context objects may be provided with a “Copy-From-Peer” action that simply copies the value for a specified peer from the peer table into that parent AVP, without changing any other values in the CER or CEA from their defaults based on the DRA configuration.

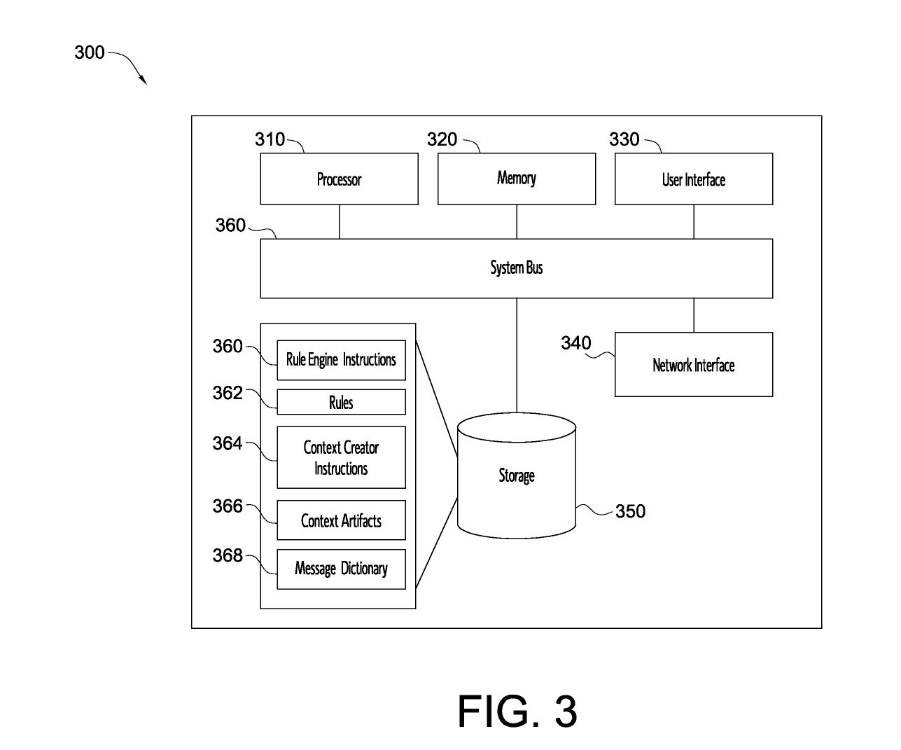

FIG. 3 illustrates an exemplary hardware diagram of a Diameter Routing Agent 300. The exemplary DRA 300 may correspond to the DRA 200 of FIG. 2 or the DRA 142 of FIG. 1. As shown, the hardware device 300 may include a processor 310, memory 320, user interface 330, network interface 340, and storage 350 interconnected via one or more system buses 360. It will be understood that FIG. 3 constitutes, in some respects, an abstraction and that the actual organization of the components of the DRA 300 may be more complex than illustrated.

The processor 310 may be any hardware device capable of executing instructions stored in memory 320 or storage 350. As such, the processor may include a microprocessor, field programmable gate array (FPGA), application-specific integrated circuit (ASIC), or other similar devices.

The memory 320 may include various memories such as, for example L1, L2, or L3 cache or system memory. As such, the memory 320 may include static random access memory (SRAM), dynamic RAM (DRAM), flash memory, read only memory (ROM), or other similar memory devices.

The user interface 330 may include one or more devices for enabling communication with a user such as an administrator. For example, the user interface 330 may include a display, a mouse, and a keyboard for receiving user commands.

The network interface 340 may include one or more devices for enabling communication with other hardware devices. For example, the network interface 340 may include a network interface card (NIC) configured to communicate according to the Ethernet protocol. Additionally, the network interface 340 may implement a TCP/IP stack for communication according to the TCP/IP protocols. Various alternative or additional hardware or configurations for the network interface 340 will be apparent.

The storage 350 may include one or more machine-readable storage media such as read-only memory (ROM), random-access memory (RAM), magnetic disk storage media, optical storage media, flash-memory devices, or similar storage media. In various embodiments, the storage 350 may store instructions for execution by the processor 310 or data upon with the processor 310 may operate. For example, the storage 350 may store rule engine instructions 360 and rules 362 read and acted upon by the rule engine. The storage 350 may also store context creator instructions 364 and the context artifacts 366, and message dictionary 368 used by the context creator as described above. It will be apparent that various information described as stored in the storage 350 may be additionally or alternatively stored in the memory 320.

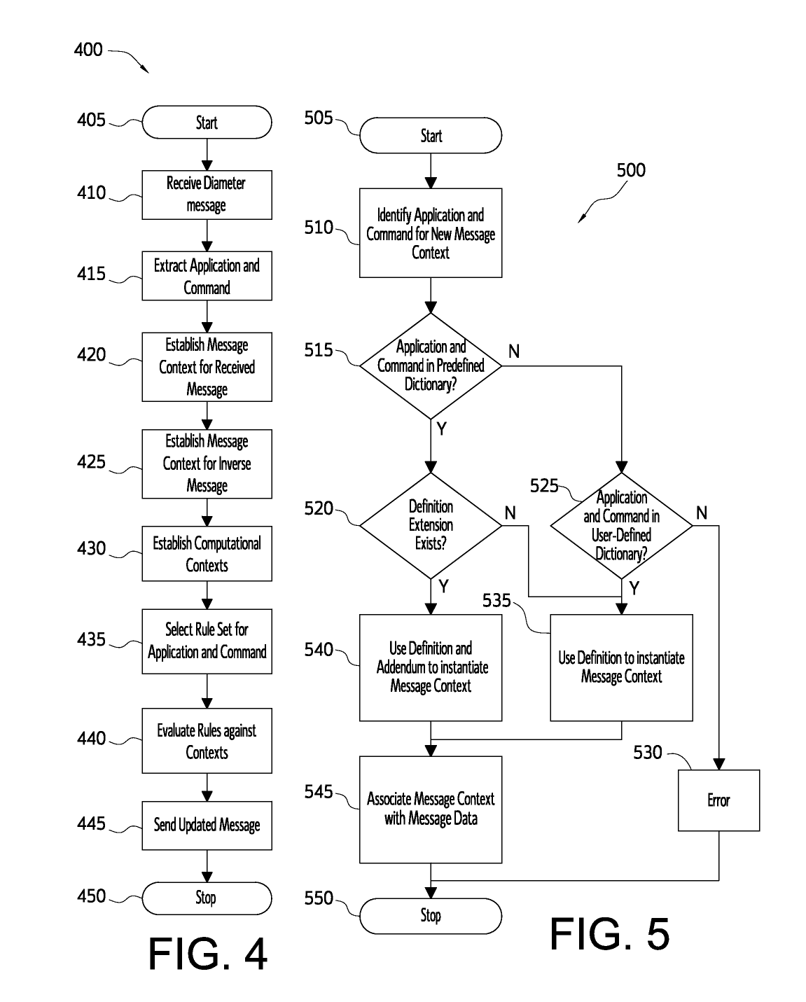

FIG. 4 illustrates an exemplary method 400 for processing Diameter messages. Method 400 may be performed by the components of DRA 200 such as, for example, Diameter stack 205, message handler 210, rule engine 215, or context creator 230.

Method 400 may begin in step 405 and proceed to step 410 where the DRA 200 may receive a Diameter message to be processed. Next, in step 415, the DRA 200 may extract a message type from the received Diameter message. In various embodiments, the message type may be defined by the application and command type of the message. Then, in step 420, the DRA may use the extracted message type to establish a message context object to wrap the received Diameter message. In a similar manner, the DRA 200 may establish a message context object for an inverse of the Diameter message in step 425. For example, the DRA 200 may use a lookup table to identify the inverse message type of the extracted message type and request a new message context based on the inverse message type.

The DRA 200 may then, in step 430, proceed to establish any other computational context objects for which the DRA 200 stores a context artifact or which the rule engine may request. For example, the DRA 200 may establish a routing decision context object and a subscriber record context object. After the appropriate context objects have been at least instantiated, method 400 may proceed to step 435 where the DRA 200 may select one or more appropriate rule sets to evaluate in processing the received Diameter message. In various embodiments, the DRA 200 may store a rule set for each message type. In some embodiments, DRA 200 may additionally or alternatively store a rule set that is generally applicable to all Diameter messages, all Diameter messages of a particular application, or another subset of Diameter messages.

After identifying the appropriate rule sets, the DRA 200 may evaluate the selected rule set or tables against the instantiated contexts in step 440. The individual rules may include references to various components of the context objects, herein referred to as “context object references.” Such components may constitute attributes or actions of the context objects. To evaluate a rule including such a reference, the DRA may access the referenced component. For example, an attribute of a context object may be used in a comparison to determine whether a rule is applicable or an action of a context object may be used in applying the result of a rule. Various additional uses for a reference to a context object will be apparent. After applying the appropriate rule sets, the DRA 200 may transmit one or more messages to other devices in step 445. For example, the DRA may forward the Diameter message, which may be modified, to another device or may transmit an answer back to the device that sent the received message. Method 400 may proceed to end in step 450.

As noted above, steps 435 and 440 may involve the evaluation of different types of rule sets. For example, in some embodiments, each message type may be associated with a rule set which applies to message of that type. Thus, one rule set may be applied for Gx CCR messages while a different rule set may be applied for Rx AAR messages. Some embodiments may also include rule sets that are generally applicable to all Diameter messages, all Diameter requests, or all Diameter answers. In such embodiments, the DRA 200 may evaluate multiple rule sets in sequence. Further, each of these “public” or “top-level” rule sets may themselves invoke the evaluation of one or more “private” or “lower level” rule sets.

FIG. 5 illustrates an exemplary method 500 for establishing a message context object. Method 500 may correspond to step 420 or step 425 of method 400. Method 500 may be performed by the components of DRA 200 such as, for example, context creator 230.

Method 500 may begin in step 505 and proceed to step 510 where the DRA 200 may identify the application and command for the new context object. For example, a context creator may receive the application and command from a message handler. Alternatively, a context creator may extract the application and command from the received Diameter message or identify an inverse message type for the message type of the received Diameter message. After determining a message type for the new context object, the DRA 200 may begin to locate a definition for the message type by querying the predefined message dictionary in step 515. If a predefined definition is available for the message type, method 500 may proceed to step 520, where the DRA 200 may attempt to locate an extension definition for the message type. If an extension definition exists, method 500 may proceed to step 540. In step 540, the DRA 200 may use both the predefined definition and extension definition to instantiate a new message context. For example, the DRA may instantiate a message context object having attributes and actions that correspond to the AVPs and other data specified by the two definitions as potentially being carried by a message having the relevant message type.

If, in step 515, the DRA 200 is unable to locate a predefined definition for the message type, method 500 may proceed instead to step 525. In step 525, the DRA 200 may attempt to locate a user-defined definition for the message types. If no such user-defined definition for the message type is available, method 500 may proceed to produce an error in step 530 and end in step 550.

If a user-defined definition is located in step 525 or if no extension definition is located in step 520, method 500 may proceed to step 535. In various embodiments, a user-defined definition may be syntactically similar to a predefined definition. In step 535, the DRA 200 may use the located definition, which may be predefined or user-defined, to instantiate a new message context. For example, the DRA 200 may instantiate a message context object having attributes and actions that correspond to the AVPs and other data specified by the definition as potentially being carried by a message having the relevant message type.

After instantiating the message context object in step 535 or step 540, method 500 may proceed to step 545. In step 545, the DRA 200 may associate the new message context object with message data. For example, if the message context object is associated with the received Diameter message, the DRA 200 may configure the context object to access fields of the received Diameter message stored in a Diameter stack. As another example, if the message context object is associated with an inverse message of the received Diameter message, such as a related request or a related answer, the DRA 200 may configure the context object to access fields of the inverse Diameter message stored in a Diameter stack. Method 500 may then proceed to end in step 550.

Various modifications to method 500 will be apparent to those of skill in the art. For example, the DRA 200 may establish a generic message context object in step 530 for use by the rule engine to provide at least some functionality. As another example, various embodiments may utilize extension definitions with respect to both predefined definitions and user-defined definitions. In such embodiments, method 500 may proceed from step 525 to step 520 when a user-defined definition is available.

FIG. 6 illustrates an exemplary method 600 for copying peer abilities into a capabilities exchange message. The method 600 may be performed by the components of the DRA 200, such as the context creator 230. The method 600 may implement a “Copy-Peer-To-Capabilities-Exchange” action of a system context object, as described above.

The method 600 may begin in step 600 and proceed to step 610 where the DRA may receive an identification of a peer. For example, a rule that referenced a “Copy-Peer-To-Capabilities-Exchange” action may also provide a peer identifier to be used by the method 600. Next, in step 615, the DRA may locate the identified peer in the peer table. This step may involve interfacing with the Diameter stack to retrieve information from the peer table maintained by the Diameter stack. Next, in step 620, the DRA may retrieve a first value from the located record. In some embodiments, the DRA may simply copy all values from the record, while in other embodiments, the DRA may only copy a specified subset of values. It will be understood that in step 620, the DRA may retrieve the next value that is to be copied, effectively ignoring any values that the DRA is not configured to copy to a capabilities exchange message as a part of the method 600.

After retrieving a value to be copied, the DRA may convert the value to an attribute-value pair (AVP) in step 625. For example, based on the record field that stored the retrieved value, the DRA may be able to determine what type of AVP is appropriate to carry the value. Thereafter, the DRA may create the appropriate AVP and insert the retrieved value. Next, in step 630, the DRA may insert the new AVP into the CER or CEA. In some embodiments, the CER or CEA may already include an AVP of the same type as the new AVP to be inserted. For example, the Diameter stack may have already populated the capabilities exchange message with the AVP based on the DRA configuration In some such embodiments, the DRA may remove the existing AVP from the message. Further modifications will be apparent. For example, the peer table may store full AVPs from a previous capabilities exchange message or the Diameter stack may provide access to the previously received capabilities exchange message for the specified peer. In such embodiments, steps 620, 625 may be replaced with one or more steps for retrieving the appropriate previously-stored AVPs.

In step 635, the DRA may determine whether the record stores any more values to be copied to the message. If so, the method 600 may loop back to step 620. Otherwise, the method may proceed to end in step 640.

In view of the foregoing, implementations of various other actions described herein will be apparent. For example, the various “Copy-From-Peer” actions may include steps similar to step 610, 615 and may differ in that such actions may locate a specific value, rather than iterating through all available values or a list of values to be copied. As another example, the “Peer-Table.Is-Connected” attribute may include steps similar to steps 610, 615 and return a Boolean based on whether a record was found or based on whether a located record indicates that a peer is currently connected. Various other modifications and implementations will be apparent.

Utilizing the above-described functionality, an operator may be provided with the ability to define rules that present alternate Diameter identities, capabilities, and other information to various devices that include non-standard implementations that do not operate correctly in the presences of a DRA or other Diameter nodes. As an example, an operator may define the following rule set using some of the above-described mechanisms to modify a CEA message passed by the Diameter stack prior to transmission:

```
RULE TABLE: Copy PCRB1 Identity
RULE SETS: Diameter CEA
IF [RULE Hide Identity]
  (System.Peer-Table.Is-Connected(Peer Origin Host = pcrf1.myRealm)
  AND
  (Diameter CER.Reception-Address = 1.2.3.4) AND
  (System.Site-Name = site1)
THEN
  (System.Peer-Table.Copy-Peer-To-Capabilities-Exchange = pcrf1.
  myRealm) AND
  (Diameter CEA.Vendor-Id.Set = 637)
```

As will be understood, the above rule may apply for a CEA when i) the peer identified by the Diameter identity “pcrf1.myRealm” is currently connected to the system, ii) the associated CER was received from IP address “1.2.3.4,” and iii) the DRA is located at a site named “site 1” (thereby enabling a user to provision this rule set to multiple, geo-redundant devices while defining different behavior for different sites). If the rule applies, the DRA may copy the capabilities the peer “pcrf1.myRealm” to the CEA, overwriting any conflicting AVPs previously added to the CEA by the Diameter stack, and then change the Vendor-Id AVP of the CEA to the value “637.” As another example, an operator may provision the following rule set to hide multi-PCRB system infrastructure when the DRA forwards a Gx RAR:

```
RULE TABLE: Pretend to be PCRB1
RULE SETS: Gx RAR
IF [RULE Hide PCRB]
  (Gx RAR.Destination-Realm = clientRealm1)
THEN
  (Gx RAR.Route-Record.Remove) AND
  (Gx RAR.Origin-State-Id.Remove) AND
  (Gx RAR.Origin-Realm.Set = alternateRealm) AND
  (Gx RAR.Origin-Host.Set = pcrb1.alternateRealm)
```

As will be understood, the above rule may apply when a received RAR message is destined for the realm “clientRealm1.” This realm may have been previously identified by the operator as including one or more devices that do not behave properly when communicating with a multi-PCRB deployment. When applicable, the rule may first remove the “Route-Record” and “Origin-State-Id” AVPs, and then set the origin realm and host of the RAR to “alternateRealm” and “pcrb1.alternateRealm,” respectively. In this manner, the RAR message may be modified such that the DRA appears to the client device as a single PCRB. Various other rule sets for facilitating interoperability will be apparent.

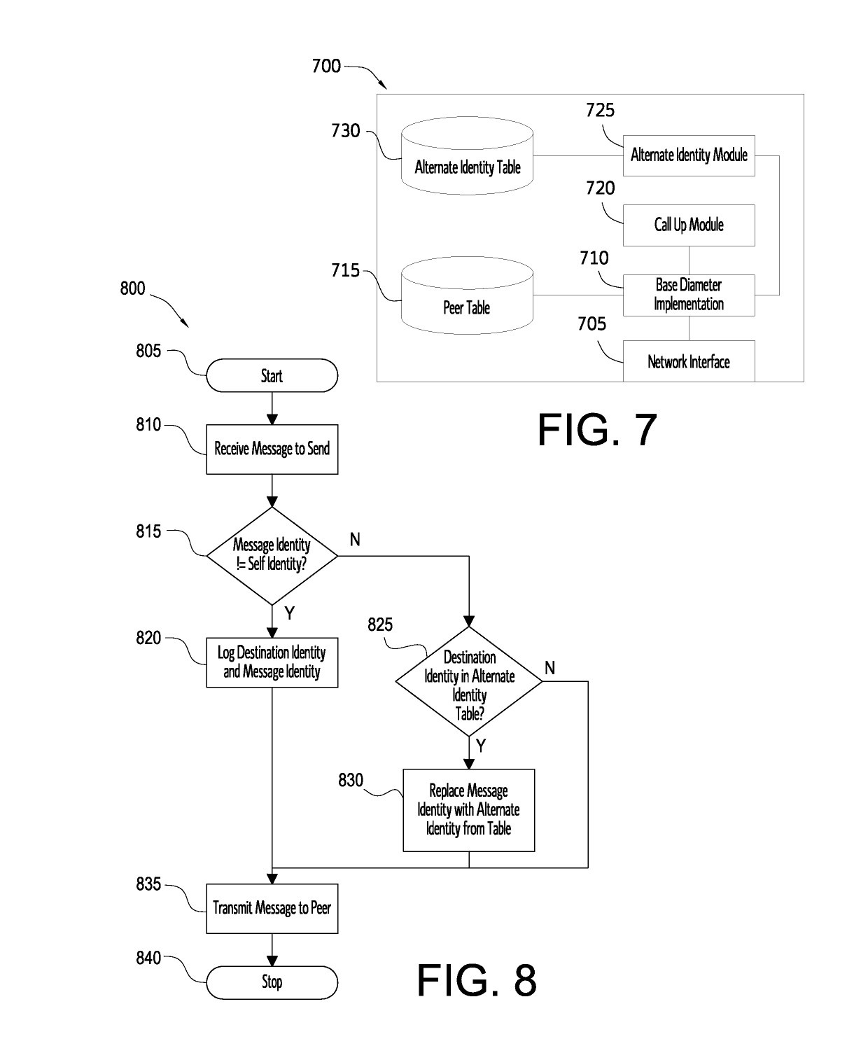

In various embodiments, the operator-provisioned modifications may be further supported by a modified Diameter stack. FIG. 7 illustrates an exemplary component diagram for a Diameter stack 700. The Diameter stack 700 may correspond to the Diameter stack 205 of the exemplary DRA 200. The Diameter stack 705 may include a network interface 705, a base Diameter implementation 710, a peer table 715, a call up module 720, an alternate identity module 725, and an alternate identity table 730. It will be apparent that the various components of the Diameter stack 700 may be implemented by lower-level hardware such as, for example, the processor 310, network interface 340, or storage 350 of the exemplary DRA 300 or similar components of a different Diameter device.

The network interface 705 may include one or more devices for enabling communication with other hardware devices. For example, the network interface 340 may include a network interface card (NIC) configured to communicate according to the Ethernet protocol. Additionally, the network interface 340 may implement a TCP/IP stack for communication according to the TCP/IP protocols. Various alternative or additional hardware or configurations for the network interface 340 will be apparent. In various embodiments, the network interface 705 may be the same as network interface 340 of the exemplary DRA 300.

The base Diameter implementation 710 may include hardware or executable instructions on a machine-readable storage medium configured to perform various functions associated with the standard Diameter protocol. For example, the base Diameter implementation 710 may send, receive, and respond to peer connect, peer disconnect, watchdog, and capabilities exchange messages. The base Diameter implementation 710 may also maintain the contents of the peer table 715 based on the receipt of such messages. The base Diameter implementation 710 may additionally receive various Diameter messages associated with higher level Diameter applications. Upon receiving such messages, the base Diameter implementation 710 may pass the message to the appropriate application module. For example, where the Diameter stack 700 is provisioned within a DRA, the base Diameter implementation 710 may receive a RAR message via the network interface 705 and pass the RAR to the DRA application module. Various other functions for base Diameter implementation 710 will be apparent in view of the relevant standards.

The peer table 715 may be any machine-readable medium capable of storing information related to peer devices. For example, the peer table may store Diameter identities of peers along with capabilities information advertised by the peer in a CEA or CER. Accordingly, the peer table 715 may include a machine-readable storage medium such as read-only memory (ROM), random-access memory (RAM), magnetic disk storage media, optical storage media, flash-memory devices, and/or similar storage media.

The call up module 720 may include hardware or executable instructions on a machine-readable storage medium configured to call up to application modules for various types of Diameter messages constructed by the base Diameter implementation 710. For example, upon the base Diameter implementation 710 constructing a new CER or CEA, the call up module 720 may pass the message to a message handler or other application-level component for further processing. Once returned, the call up module 720 may allow the base Diameter implementation 710 to send the message.

The alternate identity module 725 may include hardware or executable instructions on a machine-readable storage medium configured to learn alternate identities presented to various client devices and insert such alternate identities into various other messages. As will be described in greater detail below with respect to FIG. 8, the alternate identity module may examine outgoing messages and, when the message presents an alternate identity, log the identity in the alternate identity table 730 for later use. Then, using the logged information, may modify other messages to maintain a consistent identity. For example, the alternate identity module 725 may modify any watchdog or peer disconnect messages sent to a client device for which an alternate identity was previously used.

The alternate identity table 730 may be any machine-readable medium capable of storing client device identities in association with the alternate identity presented to the respective client devices. For example, the alternate identity table 730 may store Diameter identities of clients along with an indication of a Diameter identity previously presented to the client. Accordingly, the alternate identity table 730 may include a machine-readable storage medium such as read-only memory (ROM), random-access memory (RAM), magnetic disk storage media, optical storage media, flash-memory devices, and/or similar storage media.

FIG. 8 illustrates an exemplary method 800 for presenting an alternate identity at a Diameter stack. The method 800 may be performed by the components of a Diameter stack such as, for example, an alternate identity module 725. In various embodiments, the method 800 may only be performed for specific types of messages. For example, method 800 may be performed only when the message to be sent is a base Diameter protocol message, such as a CER or CEA.

The method 800 may begin in step 805 and proceed to step 810 where the device may receive a Diameter message to send to another device. This message may be received from a higher level application module, generated by the Diameter stack itself, or obtained in any other manner known to those of skill in the art. Next, in step 815, the device may determine whether the source identity for the message is different from the true Diameter identity assigned to the device. If so, the device may, in step 820, log the destination identity along with this alternate identity for future reference. As such, the device may remember that this particular client device was presented an alternate identity other than the true identity of the device.

If, on the other hand, the message carries the true identity of the device, the method 800 may proceed from step 815 to step 825 where the device may determine whether the message should nonetheless present an alternate identity by determining whether the alternate identity table 730 stores a record in association with the destination Diameter identity of the message. If so, the method 800 may proceed to step 830, where the device may replace the origin identity of the message with the alternate identity stored for the destination in the alternate identity table.

After logging an alternate identity in step 820, inserting an alternate identity into the message in step 830, or determining that the true Diameter identity should be presented in step 825, the device may transmit the message to a peer device in step 835. The method may then proceed to end in step 840.

It will be understood that method 800 may be a simplification of DRA operation in some respects. For example, in some embodiments, method 800 may not be applied for every type of message. Instead, the Diameter stack may call out to application components for only a subset of Diameter protocol messages, such as CER and CEA messages. Then, based on the modification to such messages, the Diameter stack may persist alternate identities for future use, in a manner similar to that described with respect to steps 815, 820. For other messages, such as Diameter watchdog requests (DWR), Diameter watchdog answers (DWA), disconnect peer requests (DPR), and disconnect peer answer (DPA), the Diameter stack may refrain from calling out to application components and, instead, may simply replace the presented identity in such messages based on previously persisted alternate identity information in a manner similar to that described with respect to steps 825, 830. Various additional modifications will be apparent.

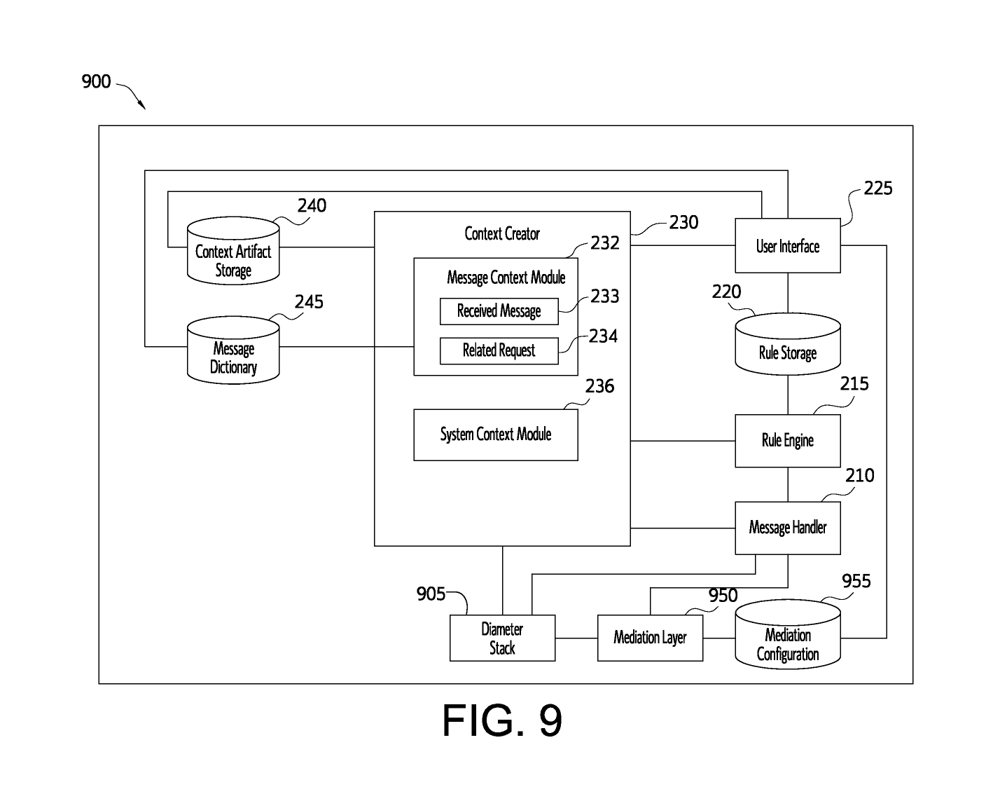

FIG. 9 illustrates an alternative embodiment of a Diameter Routing Agent 900.The DRA 900 may be mostly similar to the DRA 200 and may include many of the same components previously described. The DRA 900 may also include a modified Diameter stack 905, a mediation layer 950, and a mediation configuration storage 955.

The modified Diameter stack 905 may be similar to the Diameter stack 205 previously described except the Diameter stack 905 may be configured to call up the mediation layer 950 instead of the message handler 210 for some types of messages. For example, for CER and CEA messages and other base Diameter protocol messages, the Diameter stack 905 may pass such messages to the mediation layer 950 for processing before transmission. The Diameter stack 905 may continue to pass application-specific messages to the message handler 210 for processing.

The mediation layer 950 may include hardware or executable instructions on a machine-readable storage medium configured to perform the various interoperability functions described in the above embodiment as accomplished through operator-defined rules and accesses to context objects. For example, the mediation layer 950 may, for specific client devices, replace a true Diameter identity carried by an outgoing message with a substitute identity, as defined in the mediation configuration storage 955. Various embodiments may implement additional functionality as previously described such as, for example, hiding server topology or copying values from a peer table. As distinct from the embodiment described above, various interoperability functions performed by the mediation layer 950 may be “hard-coded” into the component and may be configured by the operator through the provisioning of configuration information into the mediation configuration storage 955.

In various alternative embodiments, the Diameter stack 905 may be configured to present some messages to both the mediation layer 950 and the message handler 210 prior to transmission. In such embodiments, the operator may be given the option of defining interoperability behaviors through defining rules or provisioning configuration information into the mediation configuration storage 955.

The mediation configuration storage 955 may be any machine-readable medium capable of storing alternate identity configuration information used by the mediation layer 950. For example, the mediation configuration storage 955 may store Diameter identities of clients along with indications of when an alternate identity should be presented to the associated client. Accordingly, the mediation configuration storage 955 may include a machine-readable storage medium such as read-only memory (ROM), random-access memory (RAM), magnetic disk storage media, optical storage media, flash-memory devices, and/or similar storage media.

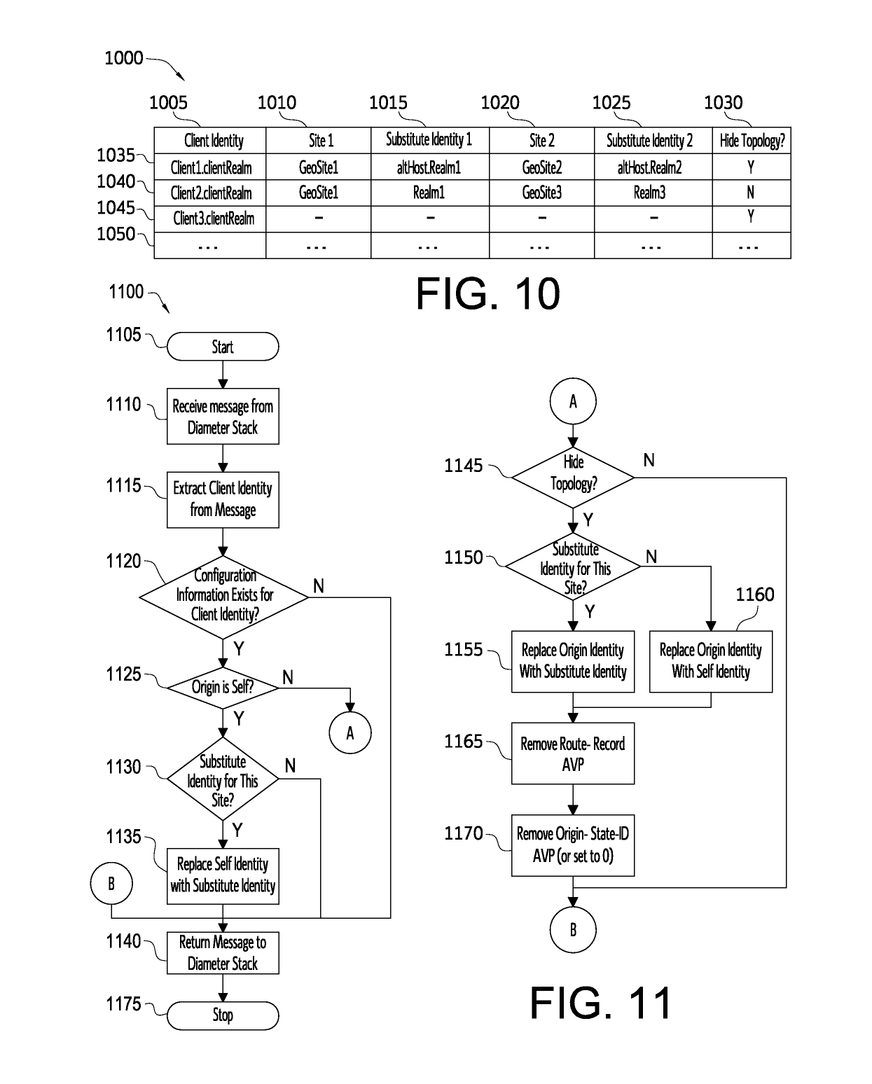

FIG. 10 illustrates an exemplary table 1000 for storing alternative Diameter identity configuration information. The table 1000 may represent the contents of a mediation configuration storage 955. It will be apparent that the table 1000 may be an abstraction and may be stored in any manner known to those of skill in the art such as, for example, a table, linked list, array, database, or other structure. The table 1000 may include a client identity field 1005, site 1 field 1010, substitute identity field 1015, site 2 field 1020, substitute identity 2 field 1025, and hide topology field 1030.

The client identity field 1005 may store an identity of a client destination for which an alternate identity may be presented. Site 1 field 1010 may store an identification of a first possible site for the DRA or other device configured with the table 1000 and may be used to determine which part of a record applies to the present DRA or other device. This may enable the provision of the same configuration information to multiple devices in a geo-redundant deployment. The substitute identity field 1015 may store an indication of a Diameter identity that should be substituted for the true identity of the device when the device is located at the site specified in the site 1 field 1010. In a similar manner, the site 2 field 1020 and substitute identity 2 field 1025 may store a different substitute identity for use when the device is located at a site identified by the value stored in site 2 field 1020. It will be understood that the table may include any number of additional site and substitute identity fields to provide for additional redundancy schemes. The hide topology field 1030 may store and indication of whether the device should replace identities of other devices carried by messages and perform other functions related to hiding realm topology.

As an example, record 1035 may indicate that, for messages destined to the client device located at Diameter identity “Client1.clientRealm”, the substitute identity “altHost.Realm1” should be inserted into the origin AVPs when the device is located in “GeoSite1.” The record 1035 may also indicate that, the substitute identity “altHost.Realm2” should be inserted into the origin AVPs when the device is located in “GeoSite2.” The record 1035 may further indicate that topology should be hidden for messages traversing the device.

As another example, record 1040 may indicate that, for messages destined to the client device located at Diameter identity “Client2.clientRealm”, the realm “Realm 1” should be inserted into the origin AVPs (while leaving the origin host intact) when the device is located in “GeoSite1.” The record 1040 may also indicate that, the realm “Realm 1” should be inserted into the origin AVPs (while leaving the origin host intact) when the device is located in “GeoSite3.” The record 1040 may further indicate that topology should not be hidden for messages traversing the device.

As yet another example, record 1045 may indicate that for messages destined to the client device located at Diameter identity “Client3.clientRealm”, the true Diameter identity for the device should be used, but topology should be hidden. As such, the true Diameter identity for the device may be inserted in place of other origin information when messages traverse the device. The table may include numerous additional records 1050.

Various alternative or additional alternative Diameter identity features may be provided for by the data arrangement 1000. For example, some embodiments may define the concept of a “serving realm,” whereby a serving realm is assigned to each client device for processing requests within a redundant system. In such embodiments, the data arrangement may additionally include a “serving realm field” (not shown) to define a serving realm for various client devices. When the DRA receives a request from a client for which a serving realm is configured and which is addressed to either the true Diameter identity of the DRA or an alternate Diameter identity configured for the client, the DRA may change the destination of the request to the configured serving realm. Then, the DRA may process the message based on the new destination realm, including, for example, locating a PCRB within the serving realm and forwarding the request accordingly. As such, the configured serving realm may be used to send requests to PCRBs located at appropriate geo-redundant sites where such geo-redundant sites are provided with unique realm names.

FIG. 11 illustrates an exemplary method 1100 for presenting an alternative Diameter identity to another device. The method 1100 may be performed by the components of a DRA 200, 300, 900 such as, for example, the mediation layer 950 or processor 310.

The method 1100 may begin in step 1105 and proceed to step 1110 where the device may receive a message from the Diameter stack. Next, in step 1115, the device extract the client identity from the message such as, for example, extracting a Diameter identity from the destination host AVP for an outbound message or from the origin-host AVP for an inbound message. Next, in step 1125, the device may determine whether configuration information is stored for the extracted client by, for example, accessing a configuration table such as table 1000. If no configuration storage is found, the method 1100 may proceed to step 1140 without modifying the message. Otherwise, the method 1100 may proceed to step 1125 where the device may determine whether the message is originating from the device itself or from some other device. If the present device is the origin of the message, the device may, in step 1130, determine whether a substitute identity has been provided for the current site. For example, the device may read a record similar to that described above in connection with FIG. 10, determine whether any of the provided sites match the currently configured site, and retrieve the associated substitute identity, if any. If there is no substitute identity configured, the method 1100 may proceed to step 1140 without modifying the message. Otherwise, the method 1100 may replace the origin host and origin realm AVPs based on the retrieved substitute identity.

If, on the other hand, the message is a routed message from some other device, the method 1100 may proceed from step 1120 to step 1145 where the device may determine whether topology hiding is configured for the client device. If not, the method may proceed to step 1140 without modifying the message. Otherwise, the method 1100 may proceed to step 1150, where the device may determine whether the message is originating from the device itself or from some other device. This step 1150 may be similar to step 1130. If a substitute identity is configured for the present site, the device may, in step 1155, replace the origin host and origin realm AVPs based on the retrieved substitute identity. This step may be similar to step 1135. If, on the other hand, a substitute identity is not configured for the present site, the device may, in step 1160, copy the device's true Diameter identity with which it is configured into the origin host and origin realm AVPs.

Next, instep 1165, the device may remove any Route-Record AVP 1165 from the message to further hide the fact that the message does not originate from the present device. Then, in step 1170, the device may either remove any Origin-State-Id AVP or set such an AVP to a code of “0” to prevent the client device from attributing a state code reported by the actual origin device to the present device. Then, the method 1100 may proceed to step 1140 where the device may return the message to the Diameter stack for transmission. The method 1100 may then proceed to end in step 1175.

According to the foregoing, various embodiments enable the facilitation of interoperability with various alternative and non-standard devices within a Diameter network. By allowing an operator to provide rules or other configuration information that presents alternate Diameter identities, capability information, and other information to specified devices, operators are able to address interoperability issues on a case-by-case basis in a robust and flexible manner. Various additional benefits will be apparent in view of the foregoing description. Further, while various examples described herein relate to a Diameter routing agent, it will be apparent that various benefits may be achieved by implementing the components, systems, and methods in other Diameter devices such as, for example, a Diameter proxy agent.

It should be apparent from the foregoing description that various exemplary embodiments of the invention may be implemented in hardware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media. Further, as used herein, the term “processor” will be understood to encompass a microprocessor, field programmable gate array (FPGA), application-specific integrated circuit (ASIC), or any other device capable of performing the functions described herein.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a Diameter device for processing a Diameter message, the method comprising:
obtaining a Diameter message to be transmitted to a client device, wherein the Diameter message includes a first Diameter identity;
determining, based on a configuration of the Diameter device, that an alternate identity is to be presented to the client device;
replacing the first Diameter identity with a second Diameter identity that is different from the first Diameter identity, based on the determination that an alternate identity is to be presented to the client device; and
transmitting the Diameter message to the client device.

2. The method of claim 1, wherein:
obtaining the Diameter message comprises generating the Diameter message, and the first Diameter identity is a true Diameter identity of the Diameter device.

3. The method of claim 1, wherein:
obtaining the Diameter message comprises receiving a Diameter message from a different Diameter device,
the first Diameter identity is a true Diameter identity of the different Diameter device, and
the second Diameter identity is at least one of a true Diameter identity of the Diameter device and a substitute Diameter identity defined by the configuration of the Diameter device.

4. The method of claim 1, wherein the configuration of the Diameter device is an externalized rule evaluated by a rule engine of the Diameter device.

5. The method of claim 1, wherein the Diameter message is one of a Capabilities Exchange Request and a Capabilities Exchange Answer, the method further comprising:
identifying a record from a Diameter peer table;
generating at least one attribute-value pair (AVP) based on the record; and
inserting the at least one AVP into the Diameter message.

6. The method of claim 1, wherein:
the first Diameter identity includes a first host name and a first realm name;
the second Diameter identity includes a second host name and a second realm name; and
the first host name is the same as the second host name.

7. The method of claim 1, further comprising:
before transmitting the Diameter message:
determining, by a Diameter stack of the Diameter device, that the second Diameter identity is different from a true Diameter identity of the Diameter device, and
storing a record of the second Diameter identity in association with an identity of the client device; and
inserting, by the Diameter stack, the second Diameter identity into at least one additional Diameter message destined for the client device based on the stored record.

8. A Diameter device for processing a Diameter message, the Diameter device comprising:
a network interface; and
a processor in communication with the network interface, wherein the processor is configured to:
provide a Diameter stack for communicating via the network interface,
wherein the Diameter stack is configured to:
obtain a Diameter message to be transmitted to a client device, wherein the Diameter message includes a first Diameter identity,
pass the Diameter message to an application of the processor, and
transmit the Diameter message to the client device after receiving the Diameter message back from the application; and
provide an application for processing Diameter messages, wherein the application is configured to:
receive the Diameter message from the Diameter stack,
determine, based on a configuration of the Diameter device, that an alternate identity is to be presented to the client device,
replace the first Diameter identity with a second Diameter identity that is different from the first Diameter identity, based on the determination that an alternate identity is to be presented to the client device, and
return the Diameter message to the Diameter stack for transmission.

9. The Diameter device of claim 8, wherein:
in obtaining the Diameter message, the Diameter stack is configured to generate the Diameter message, and
the first Diameter identity is a true Diameter identity of the Diameter device.

10. The Diameter device of claim 8, wherein:
in obtaining the Diameter message, the Diameter stack is configured to receive a Diameter message from a different Diameter device,
the first Diameter identity is a true Diameter identity of the different Diameter device, and
the second Diameter identity is at least one of a true Diameter identity of the Diameter device and a substitute Diameter identity defined by the configuration of the Diameter device.

11. The Diameter device of claim 8, wherein:
the configuration of the Diameter device is an externalized rule, and
the application is a rule engine configured to evaluate the externalized rule.

12. The Diameter device of claim 8, wherein the Diameter message is one of a Capabilities Exchange Request and a Capabilities Exchange Answer, wherein the application is further configured to:
identify a record from a Diameter peer table;
generate at least one attribute-value pair (AVP) based on the record; and
insert the at least one AVP into the Diameter message.

13. The Diameter device of claim 8, wherein:
the first Diameter identity includes a first host name and a first realm name;
the second Diameter identity includes a second host name and a second realm name; and
the first host name is the same as the second host name.

14. The Diameter device of claim 8, wherein the Diameter stack is further configured to:
determine that the second Diameter identity is different from a true Diameter identity of the Diameter device, and
store a record of the second Diameter identity in association with an identity of the client device; and
insert the second Diameter identity into at least one additional Diameter message destined for the client device based on the stored record.

15. A non-transitory machine-readable storage medium encoded with instructions for execution by a Diameter device for processing a Diameter message, the medium comprising:
instructions for obtaining a Diameter message to be transmitted to a client device, wherein the Diameter message includes a first Diameter identity;
instructions for determining, based on a configuration of the Diameter device, that an alternate identity is to be presented to the client device;
instructions for replacing the first Diameter identity with a second Diameter identity that is different from the first Diameter identity, based on the determination that an alternate identity is to be presented to the client device; and
instructions for transmitting the Diameter message to the client device.

16. The non-transitory machine-readable storage medium of claim 15, wherein:
the instructions for obtaining the Diameter message comprise instructions for generating the Diameter message, and
the first Diameter identity is a true Diameter identity of the Diameter device.

17. The non-transitory machine-readable storage medium of claim 15, wherein:
the instructions for obtaining the Diameter message comprise instructions for receiving a Diameter message from a different Diameter device,
the first Diameter identity is a true Diameter identity of the different Diameter device, and
the second Diameter identity is at least one of a true Diameter identity of the Diameter device and a substitute Diameter identity defined by the configuration of the Diameter device.

18. The non-transitory machine-readable storage medium of claim 15, wherein the configuration of the Diameter device is an externalized rule evaluated by a rule engine of the Diameter device.

19. The non-transitory machine-readable storage medium of claim 15, wherein the Diameter message is one of a Capabilities Exchange Request and a Capabilities Exchange Answer, the medium further comprising:
instructions for identifying a record from a Diameter peer table;
instructions for generating at least one attribute-value pair (AVP) based on the record; and
instructions for inserting the at least one AVP into the Diameter message.

20. The non-transitory machine-readable storage medium of claim 15, further comprising:
instructions for, before transmitting the Diameter message:
determining, by a Diameter stack of the Diameter device, that the second Diameter identity is different from a true Diameter identity of the Diameter device, and
storing a record of the second Diameter identity in association with an identity of the client device; and
instructions for inserting, by the Diameter stack, the second Diameter identity into at least one additional Diameter message destined for the client device based on the stored record.
